(19) United States
(12) Patent Application Publication
(10) Pub. No.: US 2015/0371013 A1
(43) Pub. Date: Dec. 24, 2015

(54) METHOD AND SYSTEM FOR LOCKING CONTENT

(71) Applicant: Irdeto USA, Inc., Santa Clara, CA (US)

(72) Inventors: Jonny Reckless, Santa Clara, CA (US); Nicholas Stoughton, Santa Clara, CA (US); Nicholas Pelis, Santa Clara, CA (US)

(21) Appl. No.: 14/749,191

(22) Filed: Jun. 24, 2015

Related U.S. Application Data
(63) Continuation of application No. 14/389,360, now abandoned.

(51) Int. Cl. G06F 21/10; H04L 9/08; G06F 21/16

(52) U.S. Cl. CPC G06F 21/10; G06F 21/16; H04L 9/0861; G06F 2221/0737

(57) ABSTRACT

In the present disclosure provides a method and system for locking content, such as video discs, until a release date having a first server configured for generating a daily key, a firewall couple to the first server for securing the content thereof and a second server for hosting an Internet webpage for publishing the daily disc key and coupled via the firewall to the first server for receiving the daily key therefrom. An end-user video disc player may be configured to connect to the second server via the Internet and includes executable code for retrieving the daily key from the second server or for providing a user interface for manually entering the daily key from the second server.

### RELATED APPLICATION DATA

This application is a continuation of application Ser. No. 14/389,360, which is the National Stage of International Patent Application No. PCT/US2012/031475, filed Mar. 30, 2012, the disclosures of which are hereby incorporated by reference in their entirety.

### FIELD OF THE INVENTION

The present invention relates to methods and systems for locking content and is particularly concerned with protecting content until a release date.

### BACKGROUND OF THE INVENTION

DVD and Blu-Ray discs are a well-known medium for the distribution and playback of movies in the consumer domain. These mass-produced discs store the content in optical encoded form. The disc player uses a laser to read the optical data which is further processed in the digital domain. The content is encoded using a medium specific encoding scheme.

It often is desirable for the content on the disc to be protected against redistribution over data communication networks such as the internet, in particular on peer to peer networks. The disc formats defined for DVD and Blu-Ray (player and disc) encrypt the content using keys that only can be obtained using secret information securely embedded in the content player. This makes it hard for an attacker to obtain the content in clear text form. It would be possible to re-distribute the content in encrypted format and transfer to content to a programmable optical disk. The costs and overhead of this process are fairly complex, and proves to be a sufficient deterrent in practice.

Attackers are interested in obtaining an unprotected copy of the content stored on the optical disc as that can be easily redistributed (without authorisation of the rights holders) to others over broadband communication infrastructures. With sufficient tools and time, attackers eventually will be able to find a way to remove the protection layers. An important element of the attack is that the content player needs to have the information in order to render the content that is recorded on the disc. This means that the attacker has access to all elements needed to mount an attack.

The disc player may have a connection to a broadband connection in order to receive the license to play the content. This is equivalent to a player with a DRM system, where the end user needs to obtain a license containing the information to render protected content. The delivery path of the protected content can be variable, for example, over communication networks, flash drives, portable media. One of the problems facing content providers is that they would like to distribute the media (e.g. discs) on a large scale while announcing an official release date (i.e. a ‘street’ date) after full distribution has completed. On the other hand, users, as well as potential attackers, should not be able to unlock the discs until street date.

A one way function is any function F(x)=y for which it is infeasible to obtain an inverse function F⁻¹(y)=x. An example of such a function is a hash function. Using such functions it is possible to create a series of values {xᵢ} with xₙ=F(xₙ₊₁) where any value xₙ can be used to calculate xⱼ values with a lower index value (j<n).

As described above, a DRM license can be used to unlock protected content and the unlocking information can be restricted to be only available after the release date. However, a DRM based solution is problematic as the end user needs to obtain a license for each disc in its collection. Such multiple licenses need to be stored or cached in the content player for each disc title. In case of insufficient storage in the player, the license of some discs may have to be renewed. A further disadvantage of using a DRM system is that migration of a disc collection to a new player requires the renewal of all the DRM licenses for all discs in the collection.

Systems and methods disclosed herein provide a system for locking disc content to obviate or mitigate at least some of the aforementioned disadvantages.

### SUMMARY OF THE INVENTION

An object of the present invention is to provide an improved method and system for locking content.

The present disclosure deals with protecting content, for example on optical discs up to its official release date (street date). This is achieved by publishing essential information at the release date and not earlier. The present invention protects the content on optical disks prior to the release date by only publishing essential information (e.g. a key) on the release date that is essential to process the protected content. The essential data is the same for all discs with the same release date. The essential data at a given date enables the player to calculate all essential data for any earlier date. This is accomplished by using a key chain mechanism to link the essential information for each date by way of a one way function. The release date is available on the disc in unprotected form. At the release date, the essential information is published publicly on a website, where any player can fetch the essential information and store it in the player. Alternatively, the end-user may enter the essential information using a manual entry or other input mechanism.

From the stored essential data and its associated date, the essential data for any disc with an earlier release date can be calculated by applying a one way function for each day between these two dates. Players may store some essential data from earlier dates to speed up the calculation of essential information for dates significantly far in the past. They also may use a more complicated key chain structure in order to improve calculation speed.

A further embodiment of the invention is the use of a second mechanism to selectively enable some players to unlock content prior to the release date. This selective enabling mechanism requires the player to contact a server in order to obtain the essential information to unlock the content.

With recorded content, the objective is to use any product key to unlock content. Obviously, knowledge of current product keys should not allow an attacker to be able to determine future values of a product key. If product key values are selected from a series of values {xᵢ} as described above, applying the one way function F( ) on a product key value gives an earlier product key value. For proper operation, the product key Pn is stored in combination with the sequence number ‘n’. The stored content contains metadata that comprises a sequence number (e.g. a date) and an encrypted key that unlocks the content. The sequence number is part of the key indication metadata. If the secured client holds a product key <Pₙ, n> and needs to decrypt the key of an earlier product Pⱼ (j<n), it performs ‘n-j’ one way function operations on the Pₙ to obtain the product key Pₙ₋₍ₙ₋ⱼ₎=Pⱼ. The iteration of keys produces a so called key chain.

### BRIEF DESCRIPTION OF THE DRAWINGS

The present invention will be further understood from the following detailed description with reference to the drawings in which:

FIG. 1 illustrates a system for protecting disc content in accordance with an embodiment of the present invention;

FIGS. 2A-2B illustrate in a flow chart a process for the key server updating the daily key in accordance with another embodiment of the present invention;

FIG. 3 illustrates in a flow chart a process for the disc player retrieving the daily key in accordance with a further embodiment of the present invention;

FIGS. 4A-4B illustrate a PMSN processing method.

### DETAILED DESCRIPTION OF THE PREFERRED EMBODIMENT

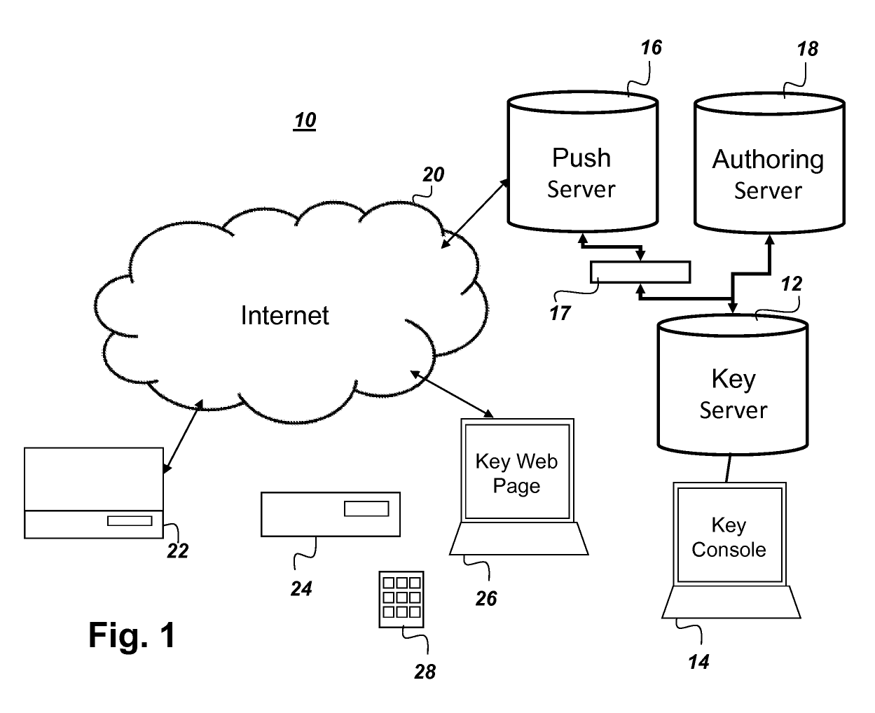

Referring to FIG. 1 there is illustrated a system for protecting disc content in accordance with an embodiment of the present invention. The system 10 includes a key server 12 and dedicated console 14, which are coupled to a push server 16 via a hardware firewall 17 and to an authoring server 18. The push server 16 is connected to the Internet 20. Some disc players 22 are capable of connection to the Internet, while other disc players 24 are standalone devices.

In operation, the Key server 12 generates a street date key each day, which is provided to the push server 16 for provision on a webpage. The key server also provides authoring servers with keys for a future day via a very secure channel to the authoring server 18, which uses the future date key for authoring discs being released on the future date. Devices such as a networked player 22, which are Internet capable can access the key without user involvement. Standalone devices such as a standalone player 24 require Internet access via a separate device, for example a personal computer (PC) 26 and manual entry using an input device 28, for example a remote control unit.

The street locking key server 12 is a secure machine that protects the root key and uses it to generate keys for specific dates. This machine is not Internet connected and has its own source of time via an attached GPS module (not shown in FIG. 1). The key server 12 is protected by a hardware firewall 18. The key server 12 also employs its own software firewall configuration that permits restricted SSH access from the push servers 16 in order to run an application with arguments (over SSH) which describes a future date, and the process returns (over SSH) the key for that day.

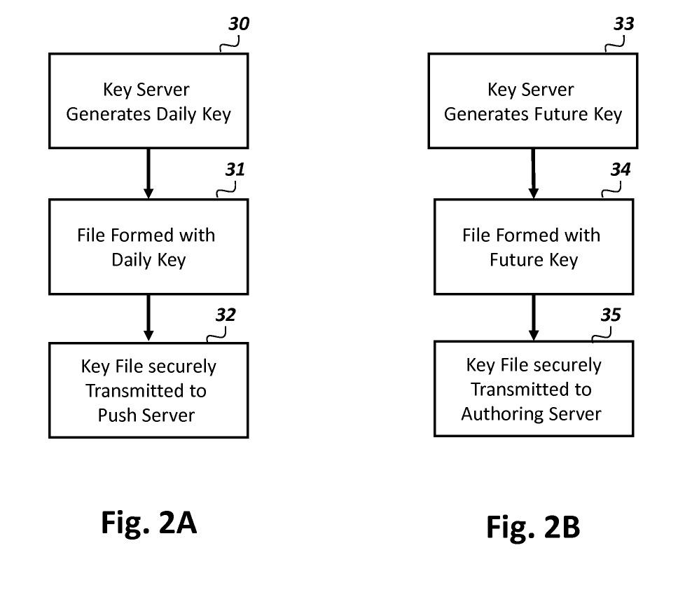

Referring to FIG. 2A, there is illustrated in a flow chart a process for the key server updating the daily key in accordance with another embodiment of the present invention. Every 24 hours the key server 12 generates daily key 30, the street locking key corresponding to the desired date (UTC). A daily key file is generated 31 A script submits a date to the street locking process listening on a UNIX domain socket. The street lock key for that date is returned and put in a file formatted for delivery and then the file is transferred 32 to the Push server or servers 16.

Referring to FIG. 2B, there is illustrated in a flow chart a process for the key server providing a future key in accordance with another embodiment of the present invention. Authoring servers 18 require a future date key in order to prepare discs for future release dates. A future key file is generated 33 by a process similar to that used for daily key. A script submits a future date to the street locking process. The street lock key for that future date is returned and put in a file formatted for delivery 34 and then the file is transferred 35 to the authoring server or servers 18.

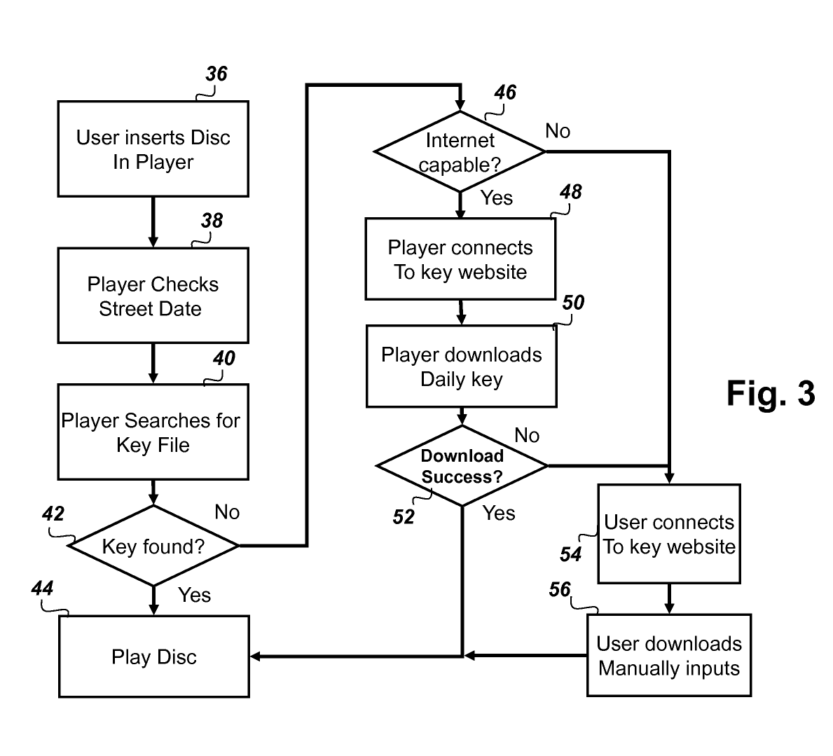

Referring to FIG. 3, there is illustrated in a flow chart a process for the disc player retrieving the daily key in accordance with a further embodiment of the present invention. For an end user with an Internet connected device such as the networked player 22, the key is obtained as follows. The user inserts a disc into their player 36. The player checks the street date on the disc 38 and searches for its memory for a key 40. If a key is found 42, the disc is played 44. If no key is found the player will need to obtain a key. The first play of the disc attempts to retrieve the current daily street-lock from the internet as described previously. No content is shown until a valid key is obtained. If Internet capable 46, the player 22 first attempts to get the key over the Internet 50 and 52. If the player is not connected to the internet, or if getting the key from the Internet fails for other reasons, a user interface 54 is prevented allowing the viewer to enter a code manually 56.

With manual key entry, the entry of a street lock key for a date earlier than the street date is detected as an invalid entry. That is, the user is re-prompted, exactly as if they had made an entry error.

Details of the street lock key are described as follows. The basis of operation is a folded hash chain, for example using SHA-1 as the hashing algorithm and for example, 80 bits as the key size. 80 bits was chosen as the smallest key size, which represents sufficient computational expense to brute force, and the largest key size, that a user might be expected to enter manually using the remote control of their Blu-ray player.

This represents 16 characters from an alphabet of 32 alphanumeric symbols (5 bits per symbol). More characters are required for error detection and correction and obtaining key ordinal. The total manual-entry code size is 20 characters.

When a street key is entered manually, it is entered as a 20 character alphanumeric string, representing a 100 bit quantity. This is generated by content_tools/scripts/street_key.py, and is encoded as a base 32 number, resulting in a 100 bit integer (MSb first). It is organized as follows:

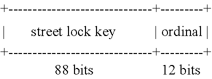

The number is represented with the following digits. “character” shows what will be shown on the web page, “alias” tells of alternate characters accepted from the disc viewer.

| digit | character | Alias |
|---|---|---|
| 0 | 0 | O, Q |
| 1 | 1 | I |
| 2 | 2 | |
| 3 | 3 | |
| 4 | 4 | |
| 5 | 5 | S |
| 6 | 6 | |
| 7 | 7 | |
| 8 | 8 | |
| 9 | 9 | |
| 10 | A | |
| 11 | B | |
| 12 | C | |
| 13 | D | |
| 14 | E | |
| 15 | F | |
| 16 | G | |
| 17 | H | |
| 18 | J | |
| 19 | K | |
| 20 | L | |
| 21 | M | |
| 22 | N | |
| 23 | P | |
| 24 | R | |
| 25 | T | |
| 26 | U | |
| 27 | V | |
| 28 | W | |
| 29 | X | |
| 30 | Y | |
| 31 | Z | |

Let K₀ be the root key, representing a street date of 01/01/2023. Then K ₁ represents the key for a street date of 12/31/2022 and so on. K ₀ should be a randomly selected large number (e.g. >=80-bits), and must be kept secret. The root key street date should be chosen far enough in the future to guarantee a long working time for the algorithm. (Street date keys do not necessarily need to be calculated from Ko each time. An intermediate key can be stored on the Key Server.) Key ordinals count down towards zero as each day passes. For example the key representing 01/18/2012 is K ₄₀₀₁

Given K ₙ, K ₙ₊₁ is computed using a one-way function (e.g. a folded SHA-1 hash

A salt value that corresponds to the N-value of the key is also used to perturb the hash at each iteration. The use of a salt value reduces the risk of an attacker of identifying the particular one-way function, should he be able to find a comprised future date key. The salt value may be concealed through methods found in U.S. Pat. No. 6,842,862, which reduces the risk of jamming attacks at the point where the key and salt values are used. The next salt value is computed through a simple function dependent on the iteration index.

Note that this file may contain historical (superfluous) keys in addition to the actual key for the present day, in order to reduce computation time for playback of older titles on players where the hash computation may be slow. This might for example include keys for the 1st day of each month of the preceding 2 years, although the protocol itself imposes no restrictions on how many keys are included and which keys are selected for inclusion.

The described chaining method in this application is independent of the one-way function and key size. Future chains may have a different key size and/or hashing algorithm. When more than one entry is included, entries shall be sorted by a chain identifier followed by key identifier. The advantage of chain and key identifiers allows the currently functioning chains to be changed at any date. For example, if a future date key has been compromised, the hash chain may be made obsolete, and a new hash chain may be issued.

As part of the measures for street-locking, a mechanism for pre-release content is required. Pre-release content is needed for a number of purposes including: testing (i.e. check discs), player vendor testing, and screen-test reviews (i.e. ‘screeners’). For street-locked discs, pre-release content discs are labeled with a pre-recorded media serial number (i.e. PMSN). For these pre-release and one-off screener discs, we describe a method unlocking prior to street date plus additional protection to mitigate ripping of the content.

To permit playback of street-locked titles prior to the street date for “private” users (testers/player vendors/reviewers/Irdeto test lab), a pre-recorded media serial number (PMSN) is applied to check discs. PMSN discs use a separate PMSN key to decrypt an essential portion of the disc needed for video playback. PMSN keys are accessible only via an online authentication transaction, and the access differs from the Street-locking internet infrastructure. Furthermore, PMSN discs feature watermarking of the video content which discourages ripping.

PMSN discs contain a method for tracking which particular PMSN corresponds to the disc which was used for the ripped content. We apply a session based marking to the content of a PMSN disc, such that on playback, as well as any ripped content playback, a forensic check can track the individual PMSN corresponding to a compromised disc, allowing the party who had access to the pre-release content to be traced.

For PMSN-based watermarking, we introduce visible artifacts into the video stream. These artifacts are placed in non-invasive manner, but are robust enough that they survive standard video transcoding methods common in video ripping. Furthermore, the insertion of these artifacts maintain syntactic compliance with the bitstream as described in the video specifications and avoid crashing the player.

Altering the normal process of fixing-up protected video, we identify a number of fix-ups for which we supply either the correct overwrite (giving corrected video), or an alternative overwrite which introduces a visible artifact. In this way, based on a dynamically modified fix-up table, each corresponding to a different PMSN, we encode a series of 1s and 0s onto the video stream, which each corruption at a known location corresponding to a 1, and each correct presentation of video at known locations corresponding to a 0. Recovery of this PMSN mark is performed by viewing the movie at known time-codes and noting whether or not the video at that point contains a visible artifact.

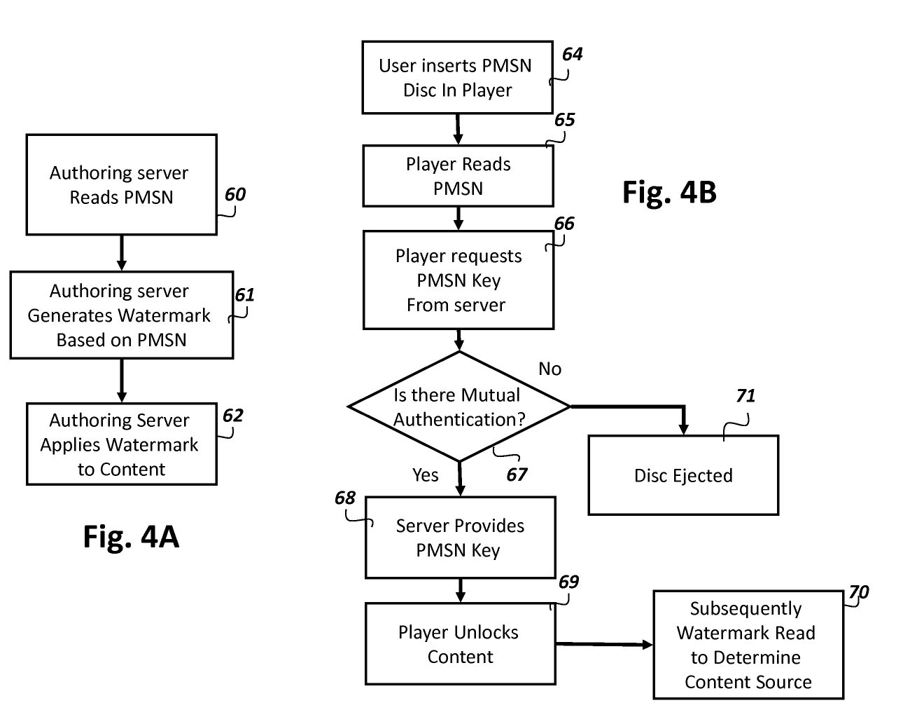

Referring to FIGS. 4A and 4B there is illustrated the PMSN processing method. As shown in FIG. 4A, when a PMSN disc is created the authoring server reads a disc specific PMSN 60. The authoring server generates 61 a watermark based upon the PMSN and applies it to the content 62. As shown in FIG. 4B, when a PMSN disc is inserted into a player 64, the player reads the PMSN 65 and requests a PMSN key 66 from the server. After a mutual authentication step 67, the server provides the key 68. The player uses the key to unlock the content 69. Subsequently, the content source can be traced from the watermark 70. If authentication fails, the disc is ejected 71.

Numerous modifications, variations and adaptations may be made to the particular embodiments described above without departing from the scope patent disclosure, which is defined in the claims.

What is claimed is:

1. A system for locking a content file until a release date comprising:
a first secured server configured for generating a current key for unlocking a content file on a current release date and a future key for unlocking a content file on a future release date;
a second secured server for hosting an Internet webpage for publishing the current key and coupled to the first server for receiving the current key therefrom;
and
a third secured server for authoring content using the future key and coupled to the first server for receiving the future key therefrom.

2. The system of claim 1, further comprising a first end-user content player configured to connect to the second server via the Internet.

3. The system of claim 2, wherein the first end-user content player includes executable code for retrieving the current key from the second server.

4. The system of claim 1, wherein the first end-user content player includes executable code for providing a user interface for manually entering the current key from the second server.

5. The system of claim 1, further comprising a stand-alone end user content player.

6. The system of claim 5, wherein the stand-alone end-user content player includes executable code for providing a user interface for manually entering the current key from the second server.

7. The system of claim 6 wherein the executable code includes a one-way function for calculating a key for an earlier release date in dependence upon a current key.

8. The system of any one of claim 7, wherein the current key for all content with a same release date are the same.

9. The system of claim 8, wherein the end-user content player includes storage for at least one current key.

10. The system of claim 9 wherein the content player uese a stored current key to unlock the content file.

11. The system of any one of claim 10, wherein a content file includes a unique pre-recorded media serial number that selectively allows unlocking of the content file prior to the release date.

12. The system of claim 11 wherein the third secured server includes a module for separately encrypting essential data with a separate PMSN key to unlock a the content file prior to the release date.

13. The system of claim 11 wherein the third secured server includes a module for watermarking PMSN content to add a tracing capability to identify which PMSN locked content file sourced content.

14. The system of claim 13 wherein the content file is at least one of an encoded video file, an audio file and a metadata file.

15. The system of claim 14 wherein the content file stored on a disc.

16. A method of locking content until a release date, the method being implemented by one or more computing devices, the method comprising:
generating, by at least one of the one or more computing devices, a current key for unlocking a content file on a current release date and a future key for unlocking a content file on a future release date;
generating, by at least one of the one or more computing devices, a first file containing the current key and a second file containing the future key;
at least one of the one or more computing devices securely sending the first file to a secured second server for hosting an Internet webpage for publishing the current key; and
at least one of the one or more computing devices securely sending the second file to a secured third server for authoring content using the future key.

17. The method of claim 16, further comprising a first end-user content player connecting to the second server to retrieve the current key.

18. The method of claim 17, wherein the first end-user content player includes executable code for retrieving the current key from the second server.

19. The method of claim 17, wherein the first end-user content player includes executable code for providing a user interface for manually entering the current key from the second server.

20. The method of claim 17, wherein a stand-alone end-user content player includes executable code for providing a user interface for manually entering the current key from the second server.

21. The method of claim 20 wherein the executable code includes a one-way function for calculating a key for an earlier release date in dependence upon the current key.

22. The method of claim 21, wherein the current key for all content with a same release date are the same.

23. The method of claim 22, wherein the end-user player stores at least one current key.

24. The method claim 22, wherein a content file includes a unique pre-recorded media serial number that allows unlocking of the content file prior to the release date.

25. The method of claim 24 further comprising the third server separately encrypting essential data with a separate PMSN key to unlock the content file prior to the release date.

26. The method of claim 24 further comprising watermarking PMSN content to add a tracing capability to identify which PMSN locked content file sourced content.

27. The method of claim 26 wherein the content file is at least one of an encoded video file, an audio file and a metadata file.

28. The method of claim 27 wherein the content file is stored on a disc.

29. A non-transient computer readable medium comprising:
an encrypted content file; and
a release date derive a key adapted to unlock the encrypted content file on the release date and prevent decrypting of the encrypted content file prior to the release date.

30. The medium of claim 29 wherein the content file is at least one of an encoded video file, an audio file and a metadata file.

31. The medium of claim 30 wherein the storage medium is an optical disc.

32. A non-transient computer readable medium having instructions stored thereon which, when executed by at least one processor, cause the at least one processor to:
generate a current key for unlocking a content file on a current release date and a future key for unlocking a content file on a future release date;
generate a first file containing the current key and a second file containing the future key;
securely send the first file to a secured second server for hosting an Internet webpage for publishing the current key; and
securely send the second file to a secured third server for authoring content using the future key.
